(19) United States
(12) Patent Application Publication
(10) Pub. No.: US 2026/0138416 A1
(43) Pub. Date: May 21, 2026

(54) HEAT DISSIPATION ASSEMBLY

(71) Applicant: Delta Electronics, Inc., Taoyuan City (TW)

(72) Inventors: Meng-Yu CHEN, Taoyuan City (TW); Kuo-Tung HSU, Taoyuan City (TW); Chih-Chung CHEN, Taoyuan City (TW); Yi-Lun LIN, Taoyuan City (TW); Yu-Kai CHANG, Taoyuan City (TW)

(21) Appl. No.: 19/336,735

(22) Filed: Sep. 23, 2025

(30) Foreign Application Priority Data
Nov. 20, 2024 (CN) 202422826929.1

(51) Int. Cl. B60H 1/00

(52) U.S. Cl. CPC B60H 1/00471

(57) ABSTRACT

A heat dissipation assembly is provided that includes a fan and a housing. The housing forms a plurality of joining structures that protrude from the outer surface of the housing, wherein the fan is disposed in the housing, and the joining structures are located in different positions of the housing. The holder is joined to one of the joining structures, thereby affixing the heat dissipation assembly to the body of the vehicle.

### CROSS REFERENCE TO RELATED APPLICATIONS

This Application claims priority of China utility model Application No. 202422826929.1, filed on Nov. 20, 2024, the entirety of which is incorporated by reference herein.

### BACKGROUND OF THE INVENTION

### Field of the Invention

The present invention relates to a heat dissipation assembly, and, in particular, it relates to a heat dissipation assembly that has a detachable holder.

### Description of the Related Art

Both electric cars as well as those with conventional engines generate heat while in operation, whether that be through an engine or a battery. In order to prevent the engine or battery from overheating and causing a functional failure of the vehicle, a cooling fan is usually provided inside the vehicle to cool the engine or battery.

A buckle structure is usually provided on the housing of the cooling fan so that the cooling fan can be affixed to the vehicle. However, conventional cooling fans with such a buckle structure may have high transportation costs, due to their large size. Moreover, since the buckle structure and the housing of the cooling fan are usually made of the same material and formed integrally as one piece, it could be difficult to maintain the high structural strength required of a cooling fan while providing flexibility of installation.

In view of this, how to design a heat dissipation assembly that can be easily assembled and suitable for use in different types of vehicles is a challenge.

### BRIEF SUMMARY OF THE INVENTION

An embodiment of the present invention provides a heat dissipation assembly that includes a fan and a housing. The housing forms a plurality of joining structures that protrude from the outer surface of the housing, wherein the fan is disposed in the housing, and the joining structures are located in different positions of the housing. The holder is joined to one of the joining structures, thereby affixing the heat dissipation assembly to the body of the vehicle.

In some embodiments, the holder has a hook that detachable hooked on the joining structure.

In some embodiments, the holder forms two grooves, and the joining structure has two guiding portions, a recess, and a connecting portion, wherein the connecting portion is connected between the guiding portions, the recess is formed between the guiding portions, and the guiding portions are received in the grooves.

In some embodiments, the hook extends in a direction that is parallel to the central axis of the fan and is hooked into the recess.

In some embodiments, the holder further forms a restricting surface, the hook protrudes from the restricting surface, and the guiding portions of the joining structure abut the restricting surface when the hook is hooked into the recess.

In some embodiments, the holder further forms two sidewalls and two ribs, and the grooves are located between the sidewalls and the ribs.

In some embodiments, the joining structure further has two recesses formed between the guiding portions, and the connecting portion is located between the recesses.

In some embodiments, the joining structure has a symmetrical shape.

In some embodiments, the joining structure has an H-shape.

In some embodiments, the holder is assembled to the joining structure in a first direction or a second direction. The second direction is the opposite of the first direction, and the first and second directions are parallel to the central axis of the fan.

### BRIEF DESCRIPTION OF THE DRAWINGS

The present invention can be more fully understood by reading the subsequent detailed description and examples with references made to the accompanying drawings, wherein:

FIG. 1 shows a perspective diagram of a vehicle V (e.g. c engine car or electric car).

FIG. 2 shows a perspective diagram of a heat dissipation assembly 100, in accordance with an embodiment of the invention.

FIG. 3 shows an exploder diagram of the heat dissipation assembly 100.

FIG. 4 shows a top view of the main body 10 of the heat dissipation assembly 100.

FIG. 5 shows a schematic diagram of the joining structure H protruding from the outer surface S of the housing 11.

FIG. 6 is another schematic diagram showing that the joining structure H protrudes from the outer surface S of the housing 11.

FIG. 7 shows a perspective view of the holder 20.

FIG. 8 shows a cross-sectional view of the holder 20 and the joining structure H in a vertical direction after assembly, wherein the vertical direction is parallel to the central axis C of the fan 12.

FIGS. 9 and 10 are cross-sectional views of the holder 20 and the joining structure H along a horizontal direction after assembly, wherein the horizontal direction is perpendicular to the central axis C of the fan 12.

### DETAILED DESCRIPTION OF THE INVENTION

The making and using of the embodiments of the heat dissipation assembly are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

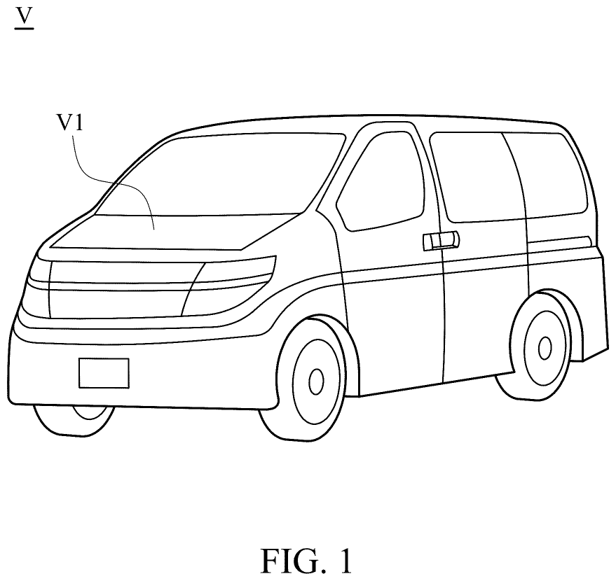

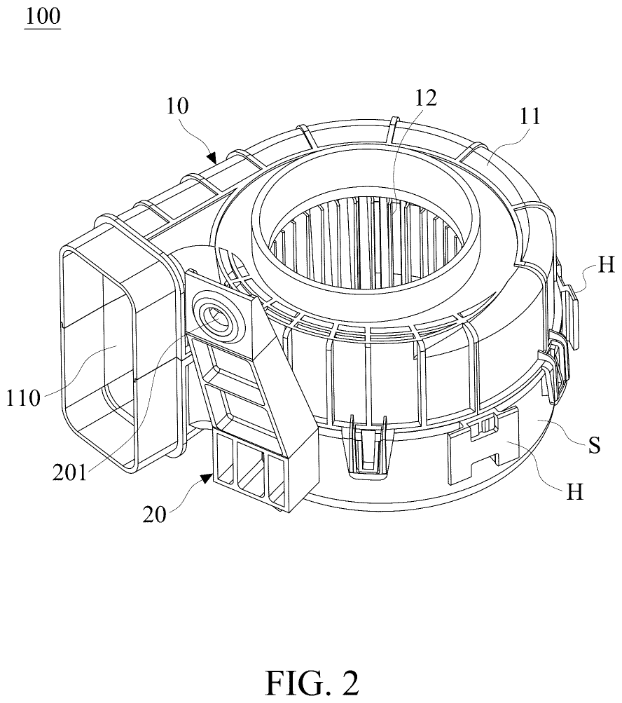

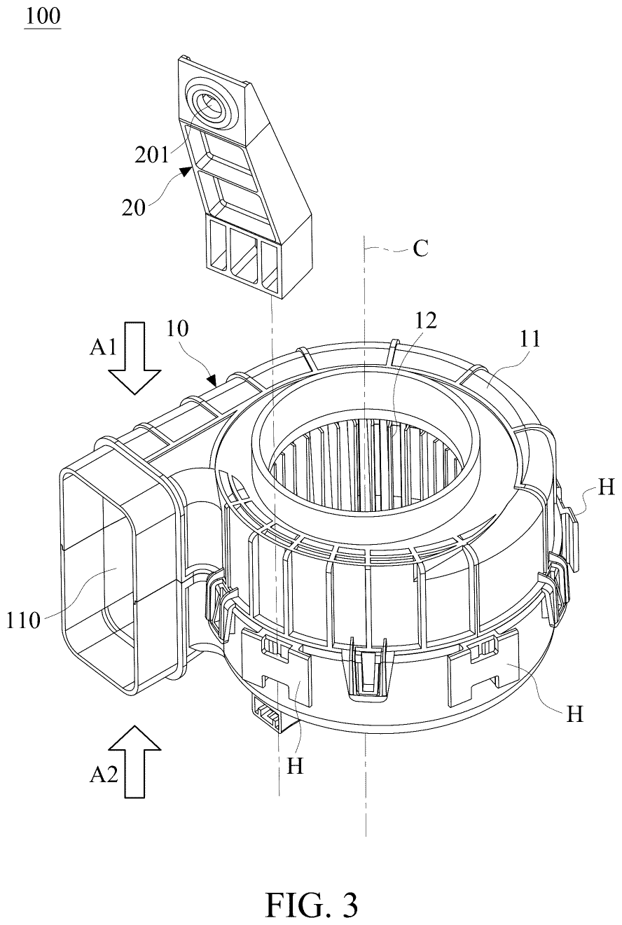

FIG. 1 shows a perspective diagram of a vehicle V (e.g. c engine car or electric car). FIG. 2 shows a perspective diagram of a heat dissipation assembly 100, in accordance with an embodiment of the invention. FIG. 3 shows an exploder diagram of the heat dissipation assembly 100.

Referring to FIGS. 1-3, the heat dissipation assembly 100 (FIGS. 2 and 3) can be disposed in the body V1 of a vehicle V (FIG. 1) for dissipating heat from the heat sources such as engines and batteries. For example, the vehicle V may be an engine car, an electric car, or other types of vehicle.

As can be seen in FIGS. 2 and 3, the heat dissipation assembly 100 in this embodiment primarily includes a main body 10 and a holder 20, wherein the main body 10 has a volute-shaped housing 11 and a fan 12 (e.g. centrifugal fan). The fan 12 is disposed in the housing 11, and the holder 20 is detachably connected to the outer surfaces S of the housing 11. During operation of the fan 12, air can be discharged through the air outlet 110 on a lateral side of the housing 11, thus dissipating heat from the heat sources (e.g. engine or a batteries) inside the vehicle V.

It should be noted that a plurality of H-shaped joining structures H are formed on the outer surface S of the housing 11. During assembly, the holder 20 can be mounted on the joining structure H, and a fastener (such as a screw) can be inserted through the hole 201 on the holder 20, thereby affixing the holder 20 to the body V1 of the vehicle V. As the main body 10 of the heat dissipation assembly 100 can be firmly connected to the body V1 of the vehicle V through the holder 20, the heat dissipation assembly 100 can be prevented from loosening from the body V1 of the vehicle V.

With the plurality of H-shaped joining structures H formed on the outer surface S of the housing 11, one or more holders 20 can be selectively joined to at least one of the H-shaped joining structures H, thereby making it suitable for use in various types of vehicles. Therefore, high compatibility and convenient use of the heat dissipation assembly 100 can be achieved.

Moreover, since each of the joining structures H in this embodiment has a symmetrical shape, the holder 20 can be joined to the joining structure H either along the first direction A1 or the second direction A2 (FIG. 3) during assembly. Here, the first and second directions A1 and A2 are opposite to each other and substantially parallel to the central axis C of the fan 12.

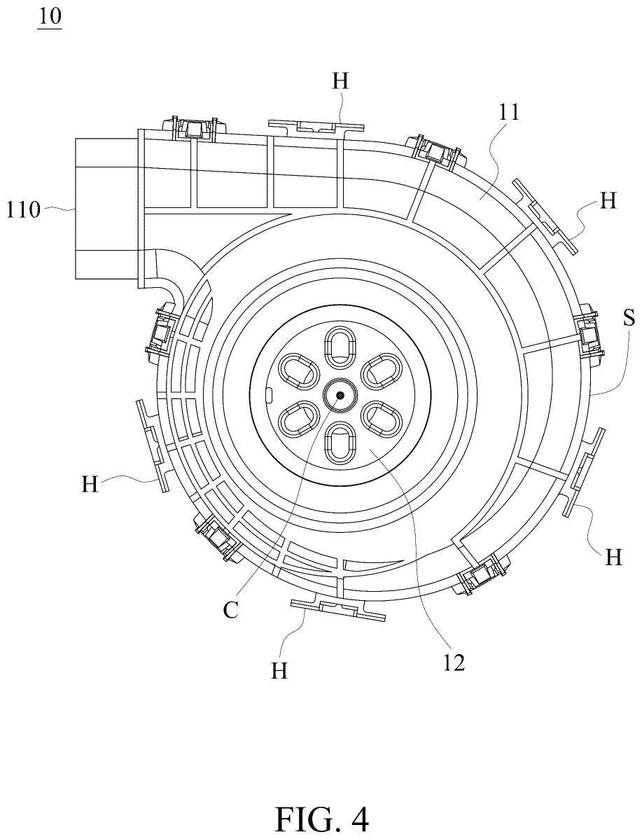

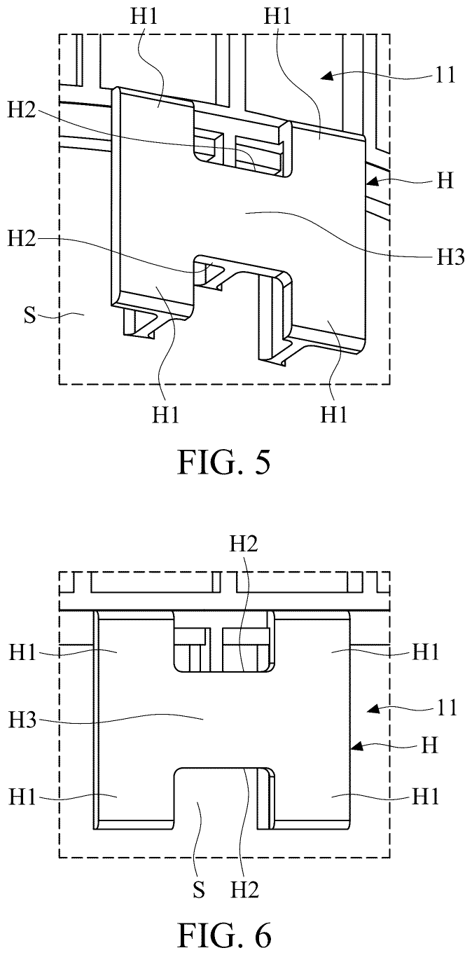

FIG. 4 shows a top view of the main body 10 of the heat dissipation assembly 100. FIG. 5 shows a schematic diagram of the joining structure H protruding from the outer surface S of the housing 11. FIG. 6 is another schematic diagram showing that the joining structure H protrudes from the outer surface S of the housing 11.

As shown in FIGS. 4, 5 and 6, each of the joining structures H protrudes from the outer surface S of the housing 11. Specifically, the joining structure H has an H-shape that comprises two guiding portions H1, two recesses H2, and a connecting portion H3. The guiding portions H1 extend in a direction parallel to the central axis C, and the connecting portion H3 is connected between the two guiding portions H1. The two recesses H2 are formed between the guiding portions H1, and the connecting portion H3 is located between the two recesses H2.

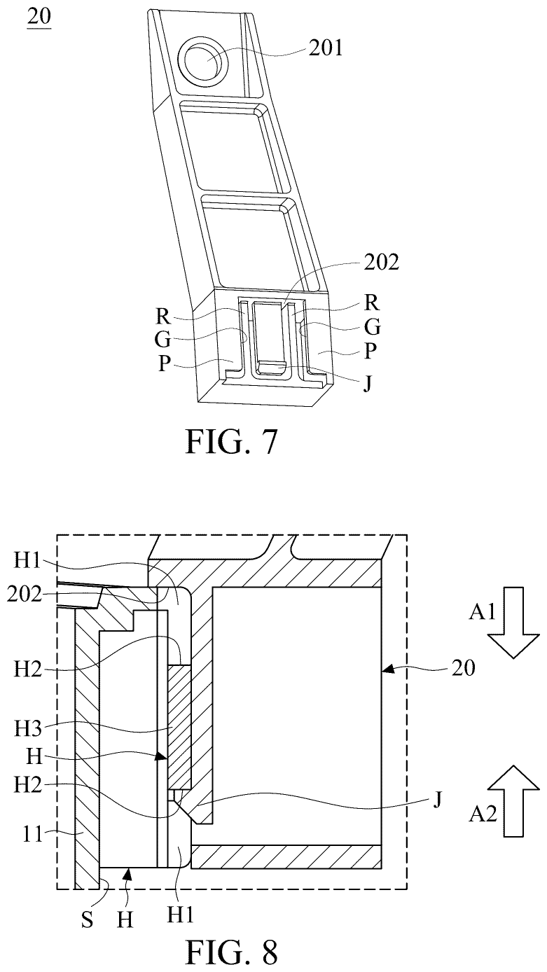

FIG. 7 shows a perspective view of the holder 20. Referring to FIG. 7, the holder 20 in this embodiment forms a longitudinal hook J, two sidewalls P, and two ribs R between the hook J and the sidewalls P. Specifically, two grooves G are formed between the sidewalls P and the ribs R for receiving the guiding portions H1 of the joining structure H. The hook J protrudes from the restricting surface 202 of the holder 20 in a direction parallel to the central axis C of the fan 12.

FIG. 8 shows a cross-sectional view of the holder 20 and the joining structure H in a vertical direction after assembly, wherein the vertical direction is parallel to the central axis C of the fan 12.

When assembling the holder 20 to the joining structure H, the hook J at the center of the holder 20 is first aligned with the connecting portion H3 at the center of the joining structure H. Subsequently, the hook J can be moved in the first direction A1 and slide along the outer surface of the connecting portion H3 until the hook J is hooked into the groove H2 of the joining structure H (FIG. 8). In the state, the end surface of the guiding portion H1 of the joining structure H abuts the restricting surface 202 of the holder 20 (FIGS. 7 and 8), whereby the holder 20 and the joining structure H are affixed to each other along the central axis C of the fan 12.

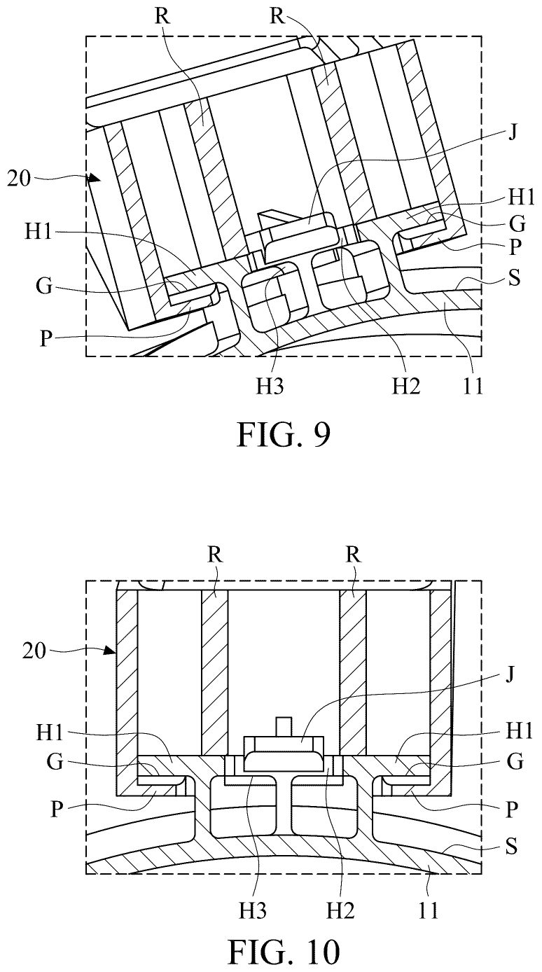

FIGS. 9 and 10 are cross-sectional views of the holder 20 and the joining structure H along a horizontal direction after assembly, wherein the horizontal direction is perpendicular to the central axis C of the fan 12.

As shown in FIGS. 9 and 10, during assembly of the holder 20 and the joining structure H, the guiding portions H1 of the joining structure H can be forced to slide along the grooves G between the sidewalls P and the ribs R. In this state, the guiding portions H1 are restricted and in contact between the sidewalls P and the ribs R. Therefore, the holder 20 can be prevented from moving relative to the joining structure H in the horizontal direction, and the structural strength and reliability of the heat dissipation assembly 100 can be improved.

In summary, the invention provides a heat dissipation assembly 100 that has a detachable holder 20 and a housing 11 with a plurality of joining structures H. The holder 20 can be selectively joined to one of the joining structures H in different positions of the housing 11. Thus, heat dissipation assembly 100 is suitable for use in various types of vehicles, whereby high compatibility and convenient use of the heat dissipation assembly 100 can be achieved.

Since the holder 20 and the main body 10 of the invention are not integrally formed in one piece, the size and the transportation cost of the dissipation assembly 100 can be greatly reduced. Moreover, as the holder 20 is detachably connected to the outer surface of the housing 11, relative positioning between the holder 20 and the housing 11 can be easily inspected by bare eyes, thus facilitating precise connection and high structural strength of the heat dissipation assembly 100.

In some embodiments, the material of the holder 20 may be adjusted and changed according to product requirements. In other words, the materials of the holder 20 and the housing 11 may be different, so that high structural strength and flexible installation of the heat dissipation assembly 100 can be both achieved.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A heat dissipation assembly, comprising:
a fan; and
a housing, forming a plurality of joining structures that protrude from an outer surface of the housing, wherein the fan is disposed in the housing, and the joining structures are located in different positions of the housing; and
a holder, joined to one of the joining structures, thereby affixing the heat dissipation assembly to a body of a vehicle.

2. The heat dissipation assembly as claimed in claim 1, wherein the holder has a hook that detachable hooked on the joining structure.

3. The heat dissipation assembly as claimed in claim 2, wherein the holder forms two grooves, and the joining structure has two guiding portions, a recess, and a connecting portion, wherein the connecting portion is connected between the guiding portions, the recess is formed between the guiding portions, and the guiding portions are received in the grooves.

4. The heat dissipation assembly as claimed in claim 3, wherein the hook extends in a direction parallel to a central axis of the fan and is hooked into the recess.

5. The heat dissipation assembly as claimed in claim 4, wherein the holder further forms a restricting surface, the hook protrudes from the restricting surface, and the guiding portions of the joining structure abut the restricting surface when the hook is hooked into the recess.

6. The heat dissipation assembly as claimed in claim 3, wherein the holder further forms two sidewalls and two ribs, and the grooves are located between the sidewalls and the ribs.

7. The heat dissipation assembly as claimed in claim 3, wherein the joining structure further has two recesses formed between the guiding portions, and the connecting portion is located between the recesses.

8. The heat dissipation assembly as claimed in claim 3, wherein the joining structure has a symmetrical shape.

9. The heat dissipation assembly as claimed in claim 3, wherein the joining structure has an H-shape.

10. The heat dissipation assembly as claimed in claim 3, wherein the holder is assembled to the joining structure in a first direction or a second direction, wherein the second direction is opposite of the first direction, and the first and second directions are parallel to a central axis of the fan.
